(19) United States
(12) Patent Application Publication
(10) Pub. No.: US 2004/0007218 A1
(43) Pub. Date: Jan. 15, 2004

(54) Low RPM turbo

(76) Inventor: Edward Lee Walker, Fairborn, OH (US)

Correspondence Address: Edward L. Walker, 806 S. Maple Ave, Fairborn, OH, 45324, US

(21) Appl. No.: 10/146,870

(22) Filed: Jul. 12, 2002

(51) Int. Cl. F02B 33/00

(52) U.S. Cl. 123/559.1

(57) ABSTRACT

This device is used to allow stock or performance engines to have 25 to 60 more horsepower. Depending on RPM ranges, the turbo can run from 4,000 to 70,000 RPM's. The low RPM turbo is designed to give instant horsepower at the flip of a switch. Because the Low RPM Turbo is electronically controlled, it is light-weight and very simple to install. The Low RPM Turbo is also universal, which means that it will mount to any car or truck. The Low RPM Turbo is also equipped with a safety harness to prevent any possible problems to the computer system and wiring harness.

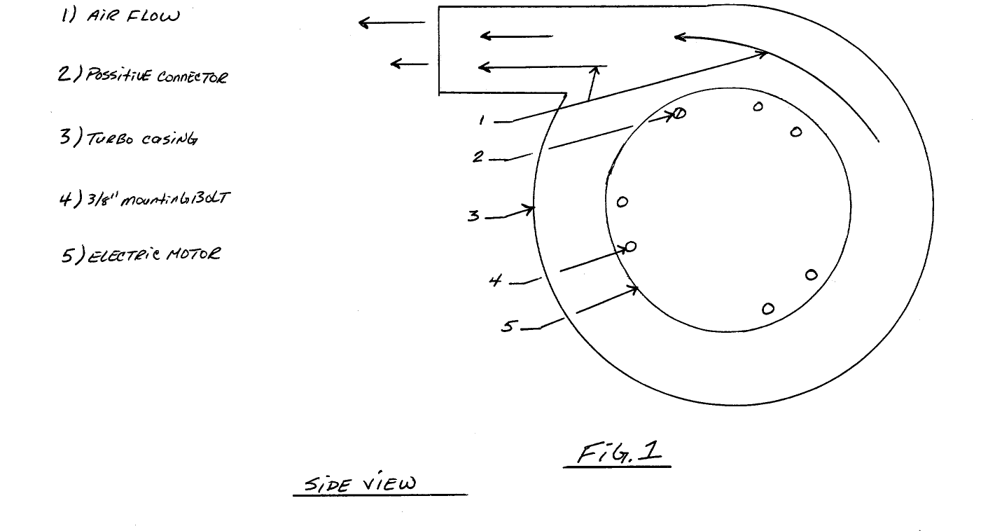

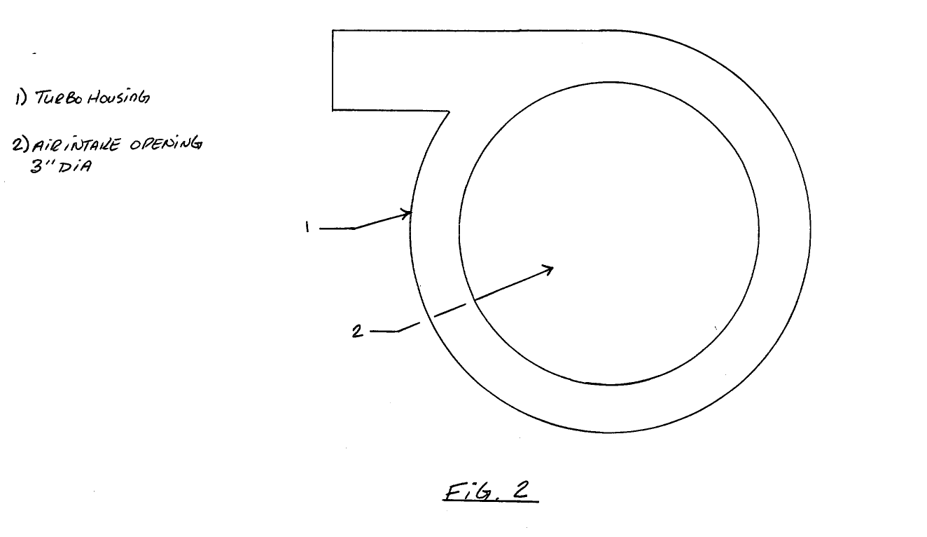

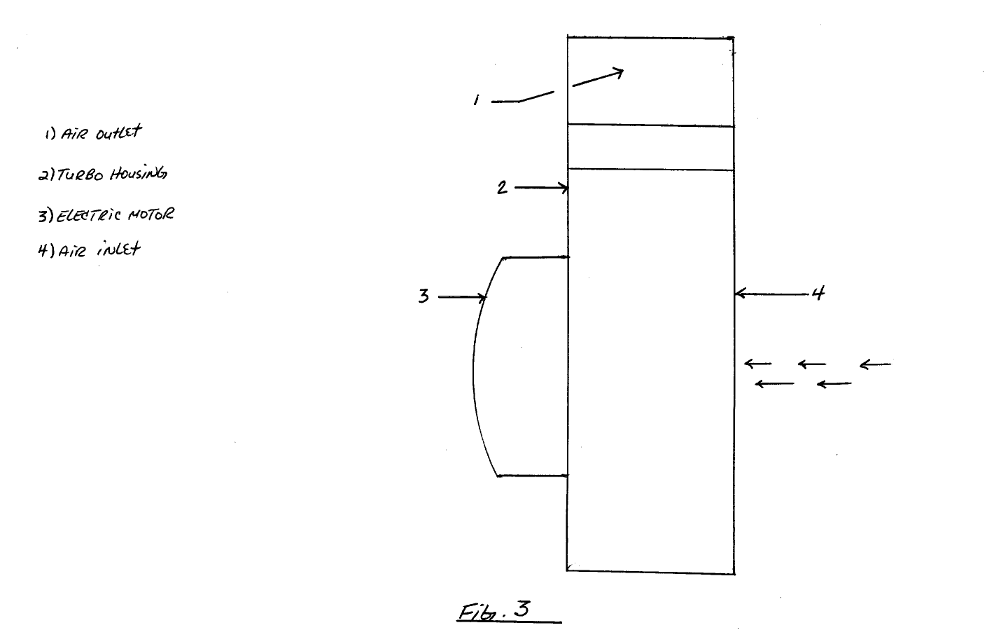

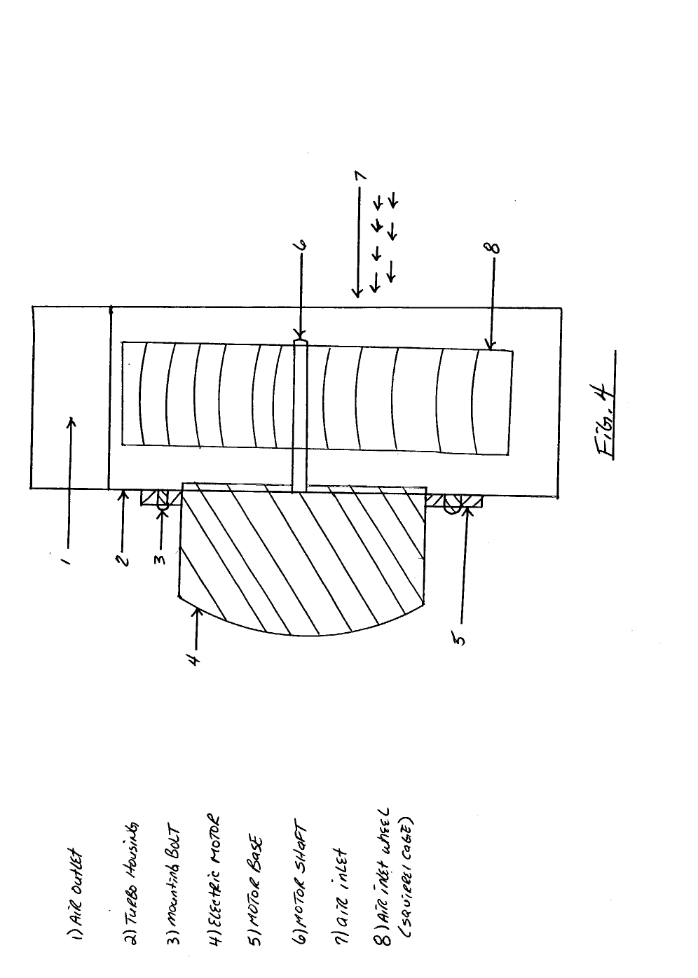

The completion of the Disclosure to ISC and Record of Invention form documents the confidential disclosure of “LOW RPM TURBO” to ISC on a given date and may help establish a record of origin and disclosure to others.

### DESCRIPTION: PRODUCT CONCEPT REVIEW

In this Information Summary, we will review the distinctive features of the invention and the needs it may fulfill. The concept of “LOW RPM TURBO”, as Mr. Walker submitted it to ISC, is an electric-powered turbocharger for the air intake system of a motor vehicle. It would pressurize the air to the throttle body for higher compression when the fuel/air mixture is burned within the cylinders. This would boost the power output of the engine at low RPM for improved performance on the road or racetrack. It would also be a fraction of the cost and complexity of conventional turbochargers and superchargers that are available to automotive enthusiasts.

The complete system would consist primarily of an electric turbocharger, modified air cleaner lid, insulated 12-volt wiring, and a toggle switch. The turbocharger would measure approximately 6 inches tall, 6½ inches wide, and 6½ inches long. The flat mounting base would be a one-piece bracket that is integrated into the motor housing. Holes would be included through the bracket for mounting to the air box assembly.

A heater blower motor would be installed within the housing that can operate at 4,000 RPM. The output portion of the turbo would have a spiral design so the air flowed more smoothly. This spiral assembly would also be a rotating end that can be adjusted to fit the particular vehicle application. A hose would be run from the output of the blower that extends to the specially designed air box.

The rectangular box would include an air cleaner lid that forces air in the direction of the throttle body while still providing room for the filter. It would have a tube molded into it that is either semicircular or round in cross section for directing the pressurized air. The front end of the box would even include a cutout so additional air can flow through the filter.

Once installed, this simple, affordable product would serve as a low-RPM turbocharger for the engine that is good for around 3,000 to 4,000 RPM or less (good up to approximately 125 mph). It would add approximately 25 horsepower to a V-8 engine, and with other bolt-on components, it would deliver approximately 40 additional horsepower. This would be achieved without changing intakes or fuel injectors or relocating pulleys or pumps.

The “LOW RPM TURBO” would be controlled with a lighted toggle switch by the shifter or on the dashboard. It may be installed on cars and light trucks for improved power and performance on the highway, especially when passing and merging into traffic. This may include installation on Firebirds, Camaros, and Mustangs (V-8 and V-6 engines). It could also be used in various racing applications for added horsepower.

Function and Appealing Features

“LOW RPM TURBO” is being suggested by Mr. Walker because he believes it would fulfill the need for pressurizing a vehicle's intake air with a motorized turbo.

The appealing features of “LOW RPM TURBO” would be its ease of use, horsepower boost, simplicity, and ease of installation. Instead of installing a very expensive and complicated turbocharger or supercharger beneath the hood, this simple electric turbo could be bolted on to boost power at low RPM. This could save the vehicle owner a considerable amount of time, effort, and money. The driver could enjoy greater power and performance behind the wheel for improved safety and travel enjoyment. This could be achieved without actually modifying the intake and fuel injectors, or relocating pumps and pulleys within the engine compartment. The on-command electric turbo would also be compact, reliable, adjustable, effective, and adaptable to different vehicles.

Historical Development

Mr. Walker was thinking of ways to boost the horsepower of his car engine without spending $10,000 for a complicated turbocharger system. He conceived the “LOW RPM TURBO” and created a working model as a direct response to this need. A working model, by reason of its visibility, tangibility, and operability, makes it easier for anyone who may become interested in the idea to have a clearer understanding of its concept and purpose. He has installed it on his own car and it has operated successfully with the desired results.

Subsequently, Mr. Walker submitted color sketches, photographs, and a written description of his invention for review by ISC. No attempts have been made to market or manufacture the “LOW RPM TURBO”.

### PRODUCTION CONSIDERATIONS

ISC's work is based on the premise that the originator has predetermined that “LOW RPM TURBO” will work, function as designed, serve the intended purpose, and accomplish those objectives desired. We do not express an opinion regarding feasibility nor do we make projections regarding the success of an idea or concept as the elements involved in marketing are many and complex.

Variations

The potential exists for varying the production of “LOW RPM TURBO” in ways which could make it more appealing to a wider range of end users. This could include producing the electric blower in smaller and larger sizes depending upon the particular vehicle application. A higher RPM motor could be added to the housing to generate even more horsepower.

“LOW RPM TURBO” might be sold in kit form for installation by individual purchasers. Kits, of course, would be directed at individuals with do-it-yourself (DIY) interests. In addition to enjoying a cost-savings by installing their own units, these individuals would also likely derive pleasure and personal fulfillment from completing the installation activity.

If “LOW RPM TURBO” becomes marketed and gains acceptance in the automotive aftermarket, there is a possibility it could be adopted by the Original Equipment Manufacturers (OEM) to be incorporated into vehicles during the manufacturing phase as standard or optional equipment.

Producibility

It appears that “LOW RPM TURBO” could be produced easily using conventional and readily available materials and manufacturing processes. No new production technology would be required.

The turbo housing could be produced of aluminum for a high strength-to-weight ratio. It could be cast to shape and machined as needed to accept the electric blower motor. The air box could be produced of a strong plastic such as injection-molded high-density polyethylene or ABS. The air transfer tubes could be made of an extruded synthetic rubber such as neoprene. Some of the other components comprising this system, such as the insulated 12-volt wiring, toggle switch, and mounting hardware, would likely be standard and readily available from other manufacturers for final assembly.

Packaging

In the event “LOW RPM TURBO” is manufactured, it will require a package. Manufacturers and marketers are becoming increasingly aware of the importance of product packaging in developing consumer recognition. Developing a package for a new product involves numerous considerations. Some packaging concerns include protection, economy, convenience, promotion, and ecology. The first task is to establish a packaging concept, or a definition of what the package should basically be or do for the particular product. Also, the manufacturer must make decisions regarding the component elements of package design, such as size, shape, materials, color, text and brand mark. The packaging elements must also be guided by decisions on pricing, advertising, and other marketing elements.

Perhaps the most important packaging concern is convenience to the consumer. For a product package to be convenient to consumers, it should be easy to open. With the rise in consumer affluence, consumers are willing to pay a little more for the convenience, appearance, dependability, and prestige of better packaging.

After a package is designed, it should be subjected to engineering tests to ensure that it will stand up under normal conditions, visual tests to ensure that the text is legible and the colors harmonious, dealer tests to ensure that dealers find the package attractive and easy to handle, and consumer tests to determine favorable or unfavorable responses.

In this section, ISC will make a suggestion regarding the physical package for “LOW RPM TURBO”. Later in this report under the PROMOTIONAL CONSIDERATIONS section, we will review the promotional aspects of product packaging.

1. I claim the use of a 12 or 24 volt motor to be used for the performance and cooling purposes on automotive and marine applications.

2. I claim the use of a 12 or 24 volt motor for performance purposes, with a centrifical design blower housing.

3. I claim the use of a standard on and off switch or the use of a RPM activation switch.

4. I claim the use of a 12 or 24 volt motor for performance purposes that spins from 4,000 to 70,000 RPM'S.
